(19) United States
(12) Patent Application Publication
(10) Pub. No.: US 2003/0110482 A1
(43) Pub. Date: Jun. 12, 2003

(54) System and method for remotely modifying software on a machine

(76) Inventors: Alan L. Ferguson, Peoria, IL (US); Steven W. O'Neal, Bartonville, IL (US); Daniel C. Wood, East Peoria, IL (US)

Correspondence Address: CATERPILLAR INC., 100 N.E. ADAMS STREET, PATENT DEPT., PEORIA, IL, 616296490

(21) Appl. No.: 10/016,785

(22) Filed: Dec. 6, 2001

(51) Int. Cl. G06F 9/44; G06F 9/445

(52) U.S. Cl. 717/168; 717/174

(57) ABSTRACT

A system and method for updating software stored in control modules on a remotely-located machine. The current machine configuration is stored in a machine and a remote system, and the configuration in the remote system is monitored to determine if an update, such as an enhancement, “bug” fix, or new version, is available. If so, the owner of the machine is remotely notified and offered the update. If the owner accepts, the update is relayed to the machine system and flashed into the appropriate control module.

### TECHNICAL FIELD

The present invention relates generally to machines having embedded software and, more particularly, to remotely updating the embedded software files.

### BACKGROUND

Modem machines contain many embedded electronic control and monitoring systems, which control and operate the machine and its components and monitor the condition of the machine, its systems, and components. The control and monitoring systems are typically comprised of several electronic control modules, each of which may have an individual function. For example, one module may control the engine of the machine and a second module may monitor the condition of the engine, i.e. temperature, speed, and the like.

The control modules conventionally contain field reprogrammable non-volatile memory, also known as “flash” memory, which allows the software stored on the module to be modified or replaced without replacing the module. Thus, new versions of the software or “bug fixes” may be flashed into the memory of the control module by a service technician without removing the module from the machine. However, as machines, especially earth working machines, are frequently located in remote areas and transferred from one work site to another, it can be difficult and expensive to locate a specific machine and send out a service technician to install new or updated software. Further, the management of such upgrades can be difficult due to compatibility issues among software files installed on the many electronic control modules.

Further, the software installed on the control modules often includes optional features or enhancements, such as additional monitoring capabilities. These optional features typically must be enabled, usually by manually inputting a code or password in the machine system, when that feature is purchased. In many cases, the optional features may not be enabled in the software due to the owner's not purchasing that particular optional upgrade when the machine is purchased. If the owner later does wish to purchase the enhancement, that necessitates a visit by a service technician to the particular machine to enable the feature.

A similar problem to those discussed above was addressed by U.S. Pat. No. 5,974,312 issued to Hayes, Jr., et al. This patent, which addressed the need to update the memory of cellular phones with software upgrades or “bug fixes,” disclosed a “wireless programmer” which, when placed near the device, established a signal with the phone or wireless device to reprogram its flash memory. The wireless programmer established a two-way data link with the device to be programmed; when the device identified such a link, it verified the signal and used the transferred data to re-program its memory. The wireless programmer then stored an identification number of the device and associated software updates.

However, Hayes, Jr., et al. did not address the need for the ability to remotely reprogram flash memory or the need for a system for owners or operators of machines to remotely request such upgrades or enhancements to their machines. In Hayes, Jr., et al. the wireless programmer must be placed near the phone or device. In addition, the wireless programmer does not allow the operator of the phone to remotely and selectively choose particular bug fixes, software version updates, and/or product enhancements. Thus, in Hayes a technician or other personnel must determine the appropriate software, store it in the wireless programmer, and the technician or other person must place the wireless programmer near the device to be updated.

It would be preferable to have a system for remotely providing updated software to a machine and for allowing an owner of a machine to remotely request such an update, thus lessening the need for skilled service technicians to make service calls on remotely-located machines.

As can be imagined, the problems inherent in updating software installed on control modules of work machines, in which exemplary manner the present invention is disclosed, is similar to the problems found in updating software in the non-volatile memory of all electric devices. Therefore, even though the present invention is disclosed in relation to a remotely-located work machine, such as an excavator, off-highway truck, or the like, the invention as disclosed may be applicable in all fields requiring software upgrades.

### SUMMARY OF THE INVENTION

It is to be understood that both the foregoing general description and the following detailed description are exemplary and explanatory only and are not restrictive of the invention as claimed.

In a first embodiment, the present invention comprises a system for updating software installed on a machine, the machine including at least one non-volatile memory for storing the software. The system comprises a remote data storage system for storing identifying information of said software, a remote processor for monitoring said remote data storage system to determine if updates are available for said software, and a remote communications system operably connected to said remote processor, said remote communications system receiving said available updates from said remote processor and relaying said available updates to said machine for storage in said non-volatile memory.

In a second embodiment, the present invention comprises a method for remotely updating software installed on a machine, the machine having at least one non-volatile memory for storing the software. The method comprises storing identifying information of said software in a remote data storage system, monitoring said remote data storage system to determine if an update of said software is available, relaying said available update from said remote data storage system to said machine, and installing said available update in said non-volatile memory.

### BRIEF DESCRIPTION OF THE DRAWINGS

The accompanying drawings illustrate exemplary embodiments of the invention and, together with the description, serve to explain the principles of the invention.

FIG. 1 is a block diagram of a system for updating software stored on a remotely-located machine consistent with an exemplary embodiment of the present invention; and

FIG. 2 is a flow chart of an exemplary embodiment of a method, consistent with the present invention, for updating software stored on a remotely-located machine.

### DETAILED DESCRIPTION

Reference will now be made in detail to embodiments of the invention, examples of which are illustrated in the accompanying drawings. Whenever possible, the same reference numbers will be used throughout the drawings to refer to the same or like parts.

In this application, in addition to any ordinary meaning, the term “operably connected” means any system or method for establishing communication and/or data transfer. Such systems or methods may include, for example, electronics, optics, radio, cellular, and/or sound techniques as well as others not expressly described herein. “Operably connected” is not intended to be limited to a hard-wired form of communication or data transfer.

In this application, in addition to any ordinary meaning, the tem “update” in reference to software means any change to the software code, such as a “bug” fix or new version of the software, embodying even minor changes to the code. In addition, an update may include enabling or disabling a pre-existing feature or enhancement in the software.

In this application, in addition to any ordinary meaning, the term “owner” means any person or entity responsible for the machine and having the authority to purchase or accept updates to the software on the machine.

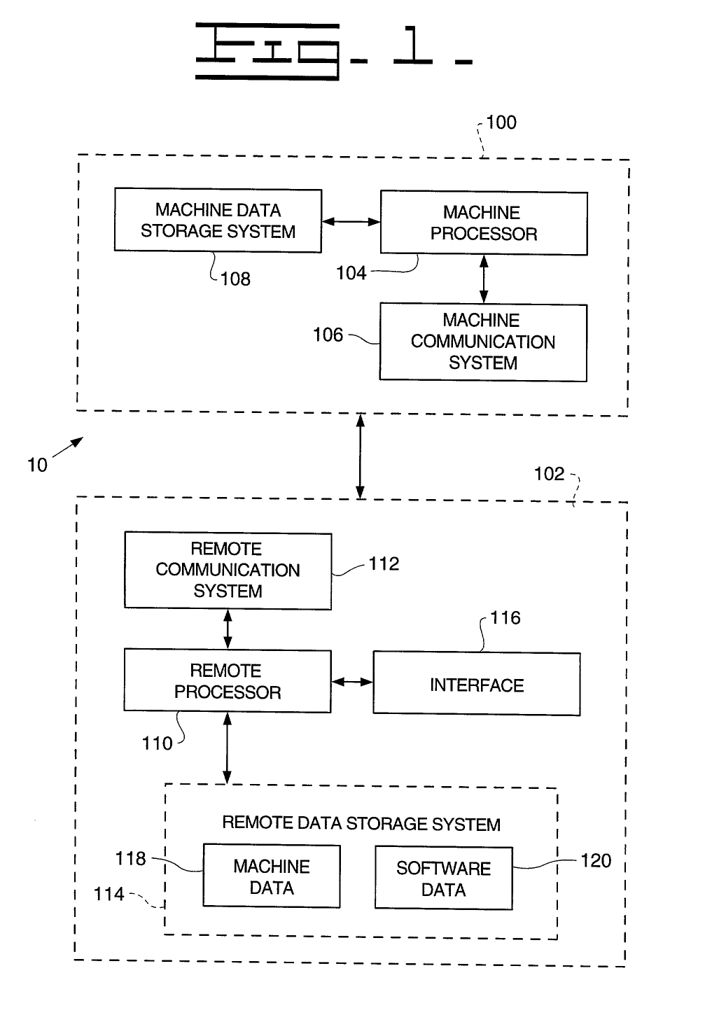

FIG. 1 illustrates a system consistent with an exemplary embodiment of the present invention, which is generally designated 10. For purposes of this disclosure, the present invention is described in connection with a remotely-located work machine, such as a track-type tractor, grader, paver, or the like. However, the present invention is equally well-suited for use with other equipment or machines having embedded software control and/or monitoring systems.

The system 10 preferably includes a machine system 100 and a remote system 102. The machine system 100 is preferably mounted on the work machine. Alternatively, the machine system 100 may have a portion located on the machine and a portion located remotely from the machine, or the entire machine system may be located remotely from the machine. The remote system 102 is preferably located remotely from the work machine.

In a first embodiment, the machine system 100 includes a machine processor 104, a machine communications system 106, and a machine data storage system 108. The machine processor 104 controls the functions of the machine system 100 and processes data received from or sent to the remote system 102 via the machine communications system 106. The machine processor 104 may be comprised of a single control unit, or it may be comprised of a more complicated control system, such as one utilizing numerous control modules or servers (preferably remotely-located), depending on the complexity of the machine system 100 needed for specific applications.

The machine communications system 106 is operably connected with the machine processor 104 and communicates with the remote system 102. Preferably, the machine communication system 106 communicates by wireless communication means, such as satellite or cellular technology, which are well-known by those skilled in the art. However, the machine communication system 106 may include an alternate communication means, such as a modem with access to public telephone lines.

The machine data storage system 108 is operably connected to the machine processor 104 and provides stored data to the machine processor 104. The machine data storage system 108 preferably is comprised of a database or other storage means capable of storing records detailing the software installed on the control modules, or non-volatile memories, on the machine, including identifying information such as serial numbers and/or version numbers. The machine data storage system 108 may be located on the machine, or it may be remote from the machine. In addition, the machine data storage system 108 may be comprised of a single database, or it may be comprised of a plurality of databases located on one or more computing devices or servers; the machine data storage system 108 may further comprise a processor or controller (not shown) for managing the storage of data.

The remote system 102 is preferably comprised of a remote processor 110, a remote communications system 112, a remote data storage system 114, and an interface 116. The remote processor 110 controls the functions of the remote system 102 and processes data received from or sent to the remote system 102 via the remote communications system 112. The remote processor 110 may be comprised of a single control unit, or it may be comprised of a more complicated control system, such as one utilizing numerous servers, depending on the complexity of the remote system 102 needed for specific applications.

Preferably, the remote communications system 112 is operably connected to and communicates with the machine system 100 by wireless communication means, such as satellite or cellular technology, which are well-known by those skilled in the art. However, the remote communications system 112 may include an alternate communication means, such as a modem with access to public telephone lines.

The remote data storage system 114 preferably includes, at least, storage space for machine data 118 and software data 120. Machine data 118 is preferably machine information specific to individual machines, preferably comprising identifying information, including version number, of the specific software stored in the control modules on the machine. The software data 120 preferably is comprised of information related to all software which may be installed on any one machine. The software data 120 may, for example, include which versions of a particular piece of software are available, software “bug fixes” which are available, and information detailing which versions of a particular piece of software are compatible with other software. Further, the software data 120 may comprise information on enhancements or optional features available on particular pieces of software and/or in particular versions of the software. The remote data storage system 114 may be comprised of a single database in which the machine data 118 and software data 120 are stored. Alternatively, the remote data storage system 114 may be comprised of a plurality of databases stored on one or more computers or servers; in addition, the remote data storage system 114 may further comprise a processor or controller (not shown) to manage the storage of data within the system. The remote data storage system 114 is operably connected to and accessible by the remote processor 110 of the remote system 102.

The interface 116 is operably connected to the remote processor 110 and provides a means for the owner of the machine to communicate with the remote system 102. The interface 116 preferably includes a display (not shown) and an operator input device, such as a keyboard (not shown). However, other types of interface means, such as, for example, a hand held computing device, voice recognition means, a touch screen, or the like, may be used to interface with the remote system 102. Further, the interface 116 may include real time or delayed communication with the remote system 102, such as an electronic mail or messaging system. And the interface 116 may be operably connected to the remote processor 110 via a private network or via an internet or other public network link. Preferably, if the interface 116 is not connected via a private network, any messages relayed between the interface 116 and the remote processor 110 will be encoded, as is well known in the art.

Operation of the system 10 is controlled by software that is programmed into the machine and remote processors 104 and 110 by external means. Alternatively, the program can be implemented via hardware or any other programming technique. Creation of this software based upon the description set forth in the specification is within the capabilities of one having ordinary skill in the programming arts.

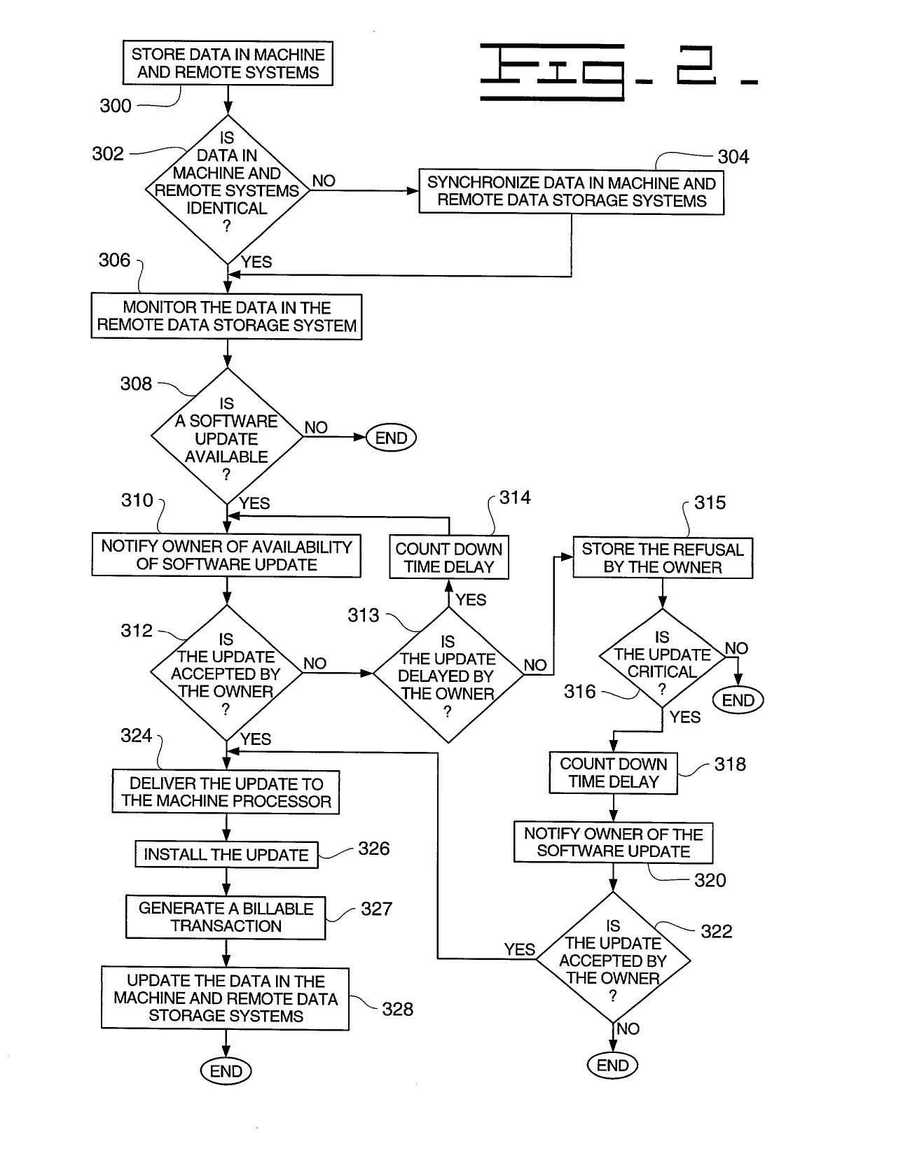

As seen in FIG. 2, in control block 300, a first set of data is stored in the remote data storage system 114, and a second set of data, which may or may not be identical to the first set of data, is stored in the machine data storage system 108. Typically, these sets of data are not simultaneously stored in their respective systems 114 and 108; one set may be stored at a time substantially earlier than when the other set is stored. In addition, within each set of data, individual items or records may be stored at different times.

The data stored in the machine data storage system 108 preferably is obtained by the machine processor 104 from polling the machine's control modules; typically, the software stored on each module contains its own identifying information, such as, for example, file serial number, version number, and enabled feature information. This identifying information may be reviewed by the machine processor 104 at regular intervals to ensure it is correct. For example, the machine processor 104 may poll each of the control modules upon every start-up to determine what software is present and enabled and then verify that information with the data stored in the machine data storage system 108. If any of the software has been modified, that change is noted, and the machine processor 104 updates the data stored in the machine data storage system 108.

In control block 302, the data in the machine data storage system 108 is compared to the machine data 118 in the remote data storage system 114. Preferably, if the identifying information in the machine data storage system 108 is different from the data stored in the machine data 118 of the remote data storage system 114, the data is synchronized, as seen in control block 304. Preferably, time or version information is associated with the data in both systems 108 and 114 to determine which data is the more recently stored and, presumably, the correct machine configuration. Typically, software files or control modules are updated on the machine when new versions are available, and the update is noted by the machine processor 104 and that information stored in the machine data storage system 108. However, if this machine system 100 were to malfunction or if the data in the machine data storage system 108 were lost, the data stored in the machine data 118 may be the most recent. Therefore, the date/time stamp, version number, or other identifier is compared for the data in the two systems 108 and 114. If the data is not identical, it is synchronized, i.e. the more recent data from each system 108 or 114 is sent to the other system 108 or 114 to replace its outdated data, via the remote and machine communication systems 112 and 106. Alternatively, rather than synchronizing the data on the two systems 108 and 114, the data stored in the machine data storage system 108 may be relayed to the remote data storage system 114. If, upon every start up of the machine, the machine processor 104 polls the control modules to verify the data stored in the machine data storage system 108 is correct, this data should be the most up-to-date of the two systems 108 and 114. If the machine system 100 malfunctions and data is lost, null sets would be relayed to the remote data storage system 114, thus providing an alert that the machine system 102 is malfunctioning.

As seen in control block 306, the machine data 118 in the remote data storage system 114 is monitored to determine if any software updates are available, as seen in control block 308. Preferably, the machine data 118 in the remote data storage system 114 is monitored by the remote processor 110 and compared to the software data 120 also stored in the remote data storage system 114. Looking, for example, at a particular piece of software, the remote processor 110 selects the identifying information from the machine data 118 and stores it in a temporary memory (not shown). The remote processor 110 then identifies the record in the software data 120 corresponding to that identifying information. From a review of that record, the remote processor 110 determines if a newer version of the software than is stored on the machine is available. The remote processor 110 determines if a “bug fix” is available for that software. The remote processor 110 determines if any optional features or enhancements are available but not enabled on the machine. Further, the remote processor 110 determines if the version of software stored on the machine is compatible with the other software stored on the machine. If any of these updates are available, the remote processor 110 stores this update information in a memory (not shown). Alternatively, the remote processor 110 may make only one or more of these determinations and store that update information in a memory. In a further embodiment, the remote processor 110 may monitor the software data 120 to determine when an update becomes available and store this update information in a temporary memory (not shown). Then, the remote processor 110 reviews the machine data 118 to determine which, if any, machines have the affected software installed; if so, this information is stored in a memory (not shown). If the remote processor 110 determines that no software updates are available, then the algorithm ends.

If a software update is available, then, as seen in control block 310, the owner of the machine is notified, preferably via the interface 116, of the availability of the update. Such a notification may be conveyed via an electronic message; however, other notification means may be used, such as, for example, generating a letter to be delivered through the general postal service or an alert delivered to a pager or cell phone. Preferably, the notification would include data detailing the current machine configuration, the updates available on the machine, the criticality of the update, and at least a summary of the issues resolved or enhancements made by the update. Further, the notification, if in electronic form, may include a link to a web site from which the owner may accept, delay, or reject the proffered update.

As seen in control block 312, the control determines if the owner accepted the available update. If not, as seen in control block 313, control determines if the owner requested a delay for making a decision on the update. If so, as seen in control block 314, the remote processor 110 counts down a time delay until the owner is notified a second time. The time delay may be set by the owner when making a request for a delay; if it is not, the remote processor 110 counts down a default delay, such as, for example, two weeks.

If the update is not accepted or delayed by the owner, the available update is assumed to be declined or refused. For the owner to decline the notification, he or she may simply not respond to the notice, may send a return notice declining the update, or may decline the update through the web site linked to the notification. As seen in control block 315, the remote processor 110 stores information relating to the fact that the offer of an update was communicated to the owner of the machine, preferably in the machine data 118, so that such an offer will normally not be sent a second time. However, as seen in control block 316, the available update is examined to determine if it is critical, such as a “bug” fix or other necessary upgrade to the software. If it is not, then no further communications are made to the owner of the machine. Alternatively, all available updates, whether critical or not, may be periodically communicated to the owner of the machine. Such communications may be ceased upon receipt of a “decline” by the owner.

However, if, as seen in control block 318, in the first embodiment the available update is critical, then the remote processor 110 counts down a time delay; in many situations, such a delay will preferably last for two weeks, allowing the owner sufficient time to respond to the initial notification. However, if at the end of the time delay, the owner has not responded to the initial notification of the critical update, a second notification is provided to the owner, as seen in control block 320, via the same or similar notification method used in control block 310. If the second notification is not accepted by the owner within a specified time period, the algorithm ends; preferably, if the owner were to later send an acceptance of the update, the acceptance would be recognized by the system, which would proceed to control block 324. Alternatively, in the case of critical updates, the machine processor may continue to send periodic notices to the owner of the available update.

If the first or second notification is accepted by the owner, control proceeds to control block 324, in which the available update is delivered to the machine processor 104. To deliver the update, the remote processor 110 retrieves the update from the software data 120 in the remote data storage system 114. Via the remote and machine communications systems 112 and 106, the remote processor 110 relays the update to the machine processor 104. Then, as seen in control block 326, the update is installed on the machine. The machine processor 104 preferably “flashes” the update into the appropriate control module, the control module being identifiable by the identifying information stored in the machine data storage system 108.

In an alternative embodiment, as seen in control block 327, upon receipt of the acceptance, the remote processor 110 may generate a billable transaction to be relayed to a billing system (not shown). If the owner's acceptance is received via a web site, the site itself may generate the transaction based upon the owner's profile. Preferably, such a transaction would not be generated if the available update were a “bug” fix, which would presumably be freely distributed.

As seen in control block 328, once the software is updated in the control module, the data stored in the machine data storage system 108 is updated with the current machine configuration. The machine processor 104 polls the control modules installed on the machine to determine the identifying information of the currently stored software, preferably including the version number. This information is stored by the machine processor 104 in the machine data storage system 108. In addition, this updated information is preferably relayed to the remote data storage system 114 to maintain the identical nature of the data stored on the two systems 108 and 114. However, the information need not be relayed immediately; the current machine configuration may be communicated to the remote system 102 during a regular, scheduled communication session, such as upon the next start-up of the machine.

### INDUSTRIAL APPLICABILITY

The present invention provides an efficient system and method for relaying software updates to a remotely-located machine. Work machines are often assigned to remote work sites, making it difficult for a technician to reach the machine to update the onboard software. Utilizing the present system disclosed herein, remotely-located work machines may be monitored from an office or other convenient location. If an update to the onboard software is available, the owner of the machine is notified remotely. Oftentimes, in large projects, the management of the project is conducted off site, and the owner may not have convenient access to the machine; thus, it is convenient for the owner to be notified remotely that updates, which may increase productivity of the machine or minimize malfunctions, are available.

If the owner wishes to have the update installed on his or her machine, the owner communicates this to the remote system 102, preferably by a return email or by accessing a web site and approving the proffered update. If there is a fee for the update, the amount to be charged may be logged in the remote system 102 or sent to a billing system (not shown) for later invoicing to the owner. The update is sent preferably via a wireless communication means to the machine system 100, where it is flashed into the memory of the appropriate control module. Thus, upgrades and enhancements may be made to the control and monitoring systems of the work machine without requiring a visit by a technician, thus decreasing maintenance costs, and proper version control for efficient operation may be maintained. In addition, the automated billing system allows for more accurate billing for enhancements and optional features, which in the past may have been enabled by an on-site technician but, often due to oversights, never billed to the owner.

It will be readily apparent to those skilled in the art that various changes and modifications of an obvious nature may be made, and all such changes and modifications are considered to fall within the scope of the appended claims. Other embodiments of the invention will be apparent to those skilled in the art from consideration of the specification and practice of the invention as disclosed herein. It is intended that the specification and examples be considered as exemplary only, with a true scope and spirit of the invention being indicated by the following claims and their equivalents.

What is claimed is:

1. A system for updating software installed on a machine, the machine having at least one non-volatile memory for storing the software, comprising:
a remote data storage system for storing identifying information of said software;
a remote processor for monitoring said remote data storage system to determine if updates are available for said software; and
a remote communications system operably connected to said remote processor, said remote communications system receiving said available updates from said remote processor and relaying said available updates to said machine for storage in said non-volatile memory.

2. The system, as set forth in claim 1, further comprising:
an interface for notifying an owner of said machine of said available update.

3. The system, as set forth in claim 2, wherein said interface allows said owner to communicate acceptance of said available update and wherein said available update is relayed to said machine upon said owner communicating said acceptance.

4. The system, as set forth in claim 3, wherein said interface includes an electronic message for notifying said owner.

5. The system, as set forth in claim 4, wherein said electronic message includes a link to a web site allowing said owner to communicate acceptance of said available update.

6. The system, as set forth in claim 3, further comprising:
a billing system operably connected to said remote processor for billing said owner for said accepted available update.

7. The system, as set forth in claim 1, further comprising:
a machine processor for polling said at least one non-volatile memory to collect said identifying information; and
a machine data storage system for storing said identifying information, said identifying information being relayed from said machine data storage system to said remote data storage system.

8. The system, as set forth in claim 7, further comprising:
a machine communication system operably connected to said machine processor, said machine communication system receiving said available update from said remote communication system.

9. The system, as set forth in claim 1, wherein said remote communication system comprises wireless communication means.

10. The system, as set forth in claim 9, wherein said wireless communication means is a cellular system.

11. The system, as set forth in claim 9, wherein said wireless communication means is a satellite system.

12. A method for remotely updating software installed on a machine, the machine having at least one non-volatile memory for storing the software, comprising:
storing identifying information of said software in a remote data storage system;
monitoring said remote data storage system to determine if an update of said software is available;
relaying said available update from said remote data storage system to said machine; and
installing said available update in said non-volatile memory.

13. The method, as set forth in claim 12, further comprising the step of:
notifying an owner of said machine of the availability of said update.

14. The method, as set forth in claim 13, further comprising the step of:
awaiting acceptance by said owner of said available update.

15. The method, as set forth in claim 14, wherein said available update is installed in said non-volatile memory if said owner accepts said available update.

16. The method, as set forth in claim 15, further comprising the step of:
billing said owner for said available update upon acceptance of said owner of said available update.

17. The method, as set forth in claim 13, wherein said owner is notified of said available update by an electronic communication.

18. The method, as set forth in claim 17, wherein said electronic communication includes a link to a web site allowing said owner to communicate acceptance of said available update.

19. The method, as set forth in claim 17, wherein said storing step includes the step of:
relaying said identifying information from said machine to said remote data storage system.

20. The method, as set forth in claim 19, wherein said storing step further includes the steps of:
polling said at least one non-volatile memory in said machine to obtain said identifying information; and
storing said identifying information in a machine data storage system.

21. The method, as set forth in claim 19, wherein said relaying step includes relaying said identifying information from a machine communication system to a remote communication system for storage in said remote data storage system.

22. The method, as set forth in claim 12, wherein said available update is relayed by a remote communication system.

23. The method, as set forth in claim 22, wherein said remote communication system comprises wireless means.

24. The method, as set forth in claim 23, wherein said wireless means is a cellular system.

25. The method, as set forth in claim 23, wherein said wireless means is a satellite system.

26. A system for updating software installed on a machine, the machine having at least one non-volatile memory for storing the software, comprising:
means for remotely storing identifying information;
means for remotely monitoring said stored identifying information to determine if updates are available, and
means for remotely communicating with the machine to relay said available updates to the machine for storage in said non-volatile memory.

27. The system, as set forth in claim 26, further comprising:
means for notifying an owner of said machine of said available update.
